(19) United States
(12) Patent Application Publication
(10) Pub. No.: US 2026/0246201 A1
(43) Pub. Date: Aug. 20, 2026

(54) Stable Conductive Terminal, Connector, and Floating Connector Assembly

(71) Applicant: Shanghai Space Appliance Co., Ltd., Putuo District, Shanghai (CN)

(72) Inventors: Xu WANG, Shanghai (CN); Jian WANG, Shanghai (CN); Zimin ZHANG, Shanghai (CN); Jun WANG, Shanghai (CN); Zhilin CHEN, Shanghai (CN)

(21) Appl. No.: 18/992,779

(22) PCT Filed: Jul. 11, 2023
(86) PCT No.: PCT/CN2023/106733

§ 371 Date: Jan. 9, 2025

(30) Foreign Application Priority Data
May 18, 2023 (CN) 202310566859.8

(51) Int. Cl. H01R 13/6464; H01R 13/24; H01R 13/502; H01R 13/631

(52) U.S. Cl. CPC H01R 13/6464; H01R 13/24; H01R 13/502; H01R 13/6315

(57) ABSTRACT

In one aspect, a stable-type electric-conducting terminal includes an electric-conducting terminal body, a first interdigital piece and a second interdigital piece that are formed on the electric-conducting terminal body. The electric-conducting terminal body is formed with an interdigital forming region, the first interdigital piece and the second interdigital piece both protrude from an inner wall of the interdigital forming region. The first interdigital piece and the second interdigital piece are parallel to each other, and an interdigital gap is formed between the first interdigital piece and the second interdigital piece. The electric-conducting terminal body is provided with a plurality of first blanking holes sequentially along an extending direction of the electric-conducting terminal body.

### CROSS-REFERENCE

This application claims priority to Chinese patent application No, 2023105668598 filed on May 18, 2023, entitled “STABLE CONDUCTIVE TERMINAL, CONNECTOR AND FLOATING CONNECTOR ASSEMBLY”, the content of which is hereby incorporated by reference in its entirety.

### TECHNICAL FIELD

The present application relates to the technical field of electrical connections, and in particular to a stable-type electric-conducting terminal, a connector, and a floating connector assembly.

### BACKGROUND

The floating connector assembly includes a first connector and a second connector. The first connector is connected to the second connector by floating insertion to realize the electrical connection therebetween. The floating connector assembly is configured to transmit a plurality of groups of high-frequency signals, meanwhile realizing a floating connection, so that the floating connector assembly has desirable tolerances and electrical connection performances.

For a connector assembly for signal transmission, especially for high-frequency signal transmission, there is a severe crosstalk problem between two adjacent electric-conducting terminals of the floating connector during signal transmission.

### SUMMARY

According to various embodiments of the present disclosure, a stable-type electric-conducting terminal, a connector, and a floating connector assembly are provided.

In a first aspect, the present disclosure provides a stable-type electric-conducting terminal, including an electric-conducting terminal body, a first interdigital piece and a second interdigital piece that are formed on the electric-conducting terminal body, wherein the electric-conducting terminal body is formed with an interdigital forming region, the first interdigital piece and the second interdigital piece both protrude from an inner wall of the interdigital forming region, the first interdigital piece and the second interdigital piece are parallel to each other, and an interdigital gap is formed between the first interdigital piece and the second interdigital piece.

The electric-conducting terminal body is formed with a plurality of floating deformation portions along an extending direction of the electric-conducting terminal body, the electric-conducting terminal body is provided with a plurality of first blanking holes sequentially along the extending direction of the electric-conducting terminal body and each floating deformation portion is provided with at least one first blanking hole.

In an embodiment, a plurality of the first blanking holes are provided, and the plurality of first blanking holes are spaced apart along a signal transmission direction of the electric-conducting terminal body.

In an embodiment, each of the first blanking holes is a curved strip-shaped slot.

In an embodiment, a center line of each first blanking hole coincides with a center line of the electric-conducting terminal body.

In an embodiment, a transverse width of each first blanking hole is constant in a direction perpendicular to an extending direction of the center line of the first blanking hole.

In an embodiment, width values of transverse widths of any two of the first blanking holes are equal.

In an embodiment, at least one of the first interdigital piece and the second interdigital piece is provided with a second blanking hole.

In an embodiment, the interdigital forming region satisfies one of the following conditions:
the interdigital forming region is formed on at least one side of the electric-conducting terminal body, and
the interdigital forming region is formed at a middle position of the electric-conducting terminal body.

In a second aspect, the present disclosure provides a connector, including the stable-type electric-conducting terminal in any one of the above-described embodiments.

In a third aspect, the present disclosure provides a floating connector assembly including the above-described connector.

Details of one or more embodiments of the present disclosure are set forth in the accompanying drawings and description below. Other features, objects, and advantages of the present disclosure will become apparent from the description, accompanying drawings, and claims.

### BRIEF DESCRIPTION OF THE DRAWINGS

To illustrate the technical solutions in the embodiments of the present disclosure or in the prior art more clearly, the accompanying drawings for describing the embodiments or the prior art are introduced briefly below in the following. Apparently, the accompanying drawings in the following description are only some embodiments of the present disclosure, and persons of ordinary skill in the art can derive other drawings from the accompanying drawings without creative efforts.

FIG. 1 is a schematic view of a floating connector assembly according to an embodiment.

FIG. 2 is a schematic cross-sectional view of the floating connector assembly shown in FIG. 1.

FIG. 3 is a schematic view of a first connector of the floating connector assembly shown in FIG. 1.

FIG. 4 is a cross-sectional view of the first connector shown in FIG. 3.

FIG. 5 is a schematic view of a stable-type electric-conducting terminal of the first connector shown in FIG. 3.

FIG. 5a is a schematic view of a stable-type electric-conducting terminal of a first connector according to another embodiment.

FIG. 6 shows an equivalent circuit diagram of a longitudinal interdigital structure.

FIG. 7 shows a simplified equivalent circuit diagram of the longitudinal interdigital structure shown in FIG. 6.

FIG. 8 shows a schematic diagram of an equivalent circuit model of an electric-conducting terminal.

FIG. 9 shows a simplified equivalent circuit diagram corresponding to the circuit model shown in FIG. 8.

FIG. 10 shows a schematic graph of the impedance curves produced by a non-interdigital or interdigital structure of the electric-conducting terminal shown in FIG. 8.

FIG. 11 shows a simplified equivalent circuit diagram of an equivalent circuit model of an electric-conducting terminal with an interdigital structure.

FIG. 12 shows a schematic diagram of crosstalk between adjacent differential signals of an electric-conducting terminal with an interdigital structure in absence or presence of a blanking hole.

FIG. 13 shows a simplified equivalent circuit diagram of an equivalent circuit model of an electric-conducting terminal with both an interdigital structure and a blanking hole.

FIG. 14 is a schematic view of a floating connector assembly according to another embodiment.

FIG. 15 is a schematic view of a stable-type electric-conducting terminal of a floating connector assembly according to still another embodiment.

FIG. 16 is a schematic view of a stable-type electric-conducting terminal of a floating connector assembly according to yet another embodiment.

### DETAILED DESCRIPTION

The embodiments of the present disclosure will be described in detail below, in order to make the above objects, features and advantages of the present disclosure more apparent and understandable. Numerous specific details are set forth in the following description in order to facilitate a thorough understanding of the present disclosure. However, the present disclosure can be implemented in many other ways than those describe herein, and similar modifications can be made by those skilled in the art without departing from the concept of the present disclosure, and thus the present disclosure is not limited to the embodiments disclosed below.

In the description of the present disclosure, it should be understood that, the orientation or position relationships indicated by the terms “central”, “longitudinal”, “transverse”, “length” “width”, “thickness”, “upper” “lower”, “front”, “back”, “left”, “right”, “vertical” “horizontal”, “top”, “bottom”, “inner”, “outer”, “clockwise”, “counterclockwise”, “axial”, “radial”, “circumferential”, and the like are based on the orientation or position relationships shown in the accompanying drawings and are intended to facilitate the description of the present disclosure and simplify the description only, rather than indicating or implying that the apparatus or element referred to must have a particular orientation or be constructed and operated in a particular orientation, and therefore are not to be interpreted as limiting the present disclosure.

In the description of the present disclosure, the terms “first” and “second” are used for descriptive purposes only, and cannot be construed as indicating or implying a relative importance, or implicitly specifying the number of the indicated technical features. Thus, the feature defined with “first” or “second” may explicitly or implicitly include one or more features. In the description of the present disclosure, “a plurality of” means two or more, such as two or three, unless otherwise defined explicitly and specifically.

In the present disclosure, unless otherwise specified and defined explicitly, the terms “install”, “connect”, “join”, and “fix” should be understood in abroad sense. For example, unless otherwise defined explicitly, they may refer to a fixed connection, a detachable connection, or an integral connection, may refer to a mechanical connection or electrical connection, and may refer to a direct connection, an indirect connection via an intermediate medium, an internal connection between two elements, or interaction between two elements. Those of ordinary skill in the art can understand specific meanings of these terms in the present disclosure based on specific circumstances.

In the present disclosure, unless otherwise specified and defined explicitly, the expression a first feature being “on” or “under” a second feature may be the case that the first feature is in direct contact with the second feature, or the first feature is in indirect contact with the second feature via an intermediate medium. Furthermore, the first feature being “over”, “above” or “on top of” the second feature may be the case that the first feature is directly above or obliquely above the second feature, or only means that the level of the first feature is higher than that of the second feature. The first feature being “below”, “underneath” or “under” the second feature may be the case that the first feature is directly underneath or obliquely underneath the second feature, or only means that the level of the first feature is lower than that of the second feature.

It should be noted that when one element is referred to as “fixed to” or “arranged on” another element, it may be directly disposed on the other element or an intermediate element may exist. When one element is considered to be “connected to” another element, it may be directly connected to the other element or an intermediate element may co-exist. The terms “vertical”, “horizontal”, “upper”, “lower”, “left”, “right” and similar expressions used herein are for illustrative purposes only and do not represent the only implementation.

The present disclosure provides a stable-type electric-conducting terminal, including an electric-conducting terminal body, a first interdigital piece and a second interdigital piece that are formed on the electric-conducting terminal body. The electric-conducting terminal body is formed with an interdigital forming region. The first interdigital piece and the second interdigital piece both protrude from an inner wall of the interdigital forming region. The first interdigital piece and the second interdigital piece are parallel to each other, and an interdigital gap is formed between the first interdigital piece and the second interdigital piece. The electric-conducting terminal body is formed with a plurality of floating deformation portions along an extending direction of the electric-conducting terminal body. The electric-conducting terminal body is provided with a plurality of first blanking holes sequentially along the extending direction of the electric-conducting terminal body. Each floating deformation portion is provided with at least one first blanking hole.

In the above-described stable-type electric-conducting terminal, the electric-conducting terminal body is formed with the interdigital forming region, and the first interdigital piece and the second interdigital piece both protrudes from the inner wall of the interdigital forming region. The first interdigital piece and the second interdigital piece are parallel to each other, and the interdigital gap is formed therebetween, so that the stable-type electric-conducting terminal form an inter-capacitance zone in the interdigital forming region, improving the capacitance of the stable-type electric-conducting terminal in the interdigital forming region, and thus enabling the stable-type electric-conducting terminal to have desirable inductive reactance. Moreover, the electric-conducting terminal body is formed with the plurality of floating deformation portions in the extending direction thereof. The electric-conducting terminal body is sequentially formed with the plurality of first blanking holes in the extending direction thereof. Each of the floating deformation portions is provided with at least one first blanking hole. As such, the electric-conducting terminal body has desirable floating performance and inductive reactance, and meanwhile the stable-type electric-conducting terminal have a desirable band-pass filtering effect on high-frequency signal transmission, that is, have an obvious function of band-pass filtering on high-frequency signal transmission, thus avoiding a severe crosstalk problem existing between two adjacent electric-conducting terminals of the floating connector in the signal transmission process.

In order to better understand the technical solutions and beneficial effects of the present disclosure, the present disclosure will be further described in detail below with reference to specific embodiments.

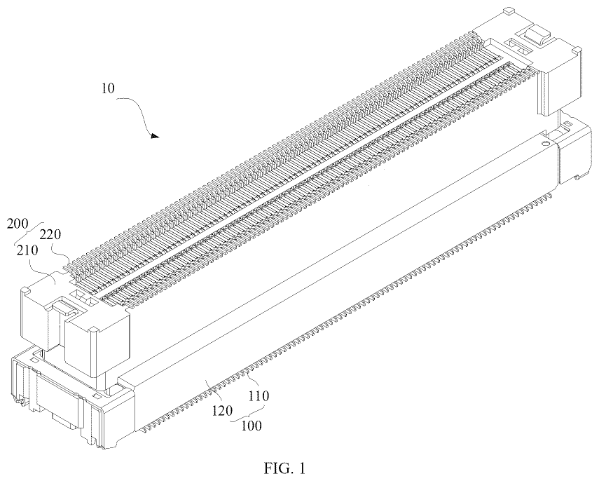

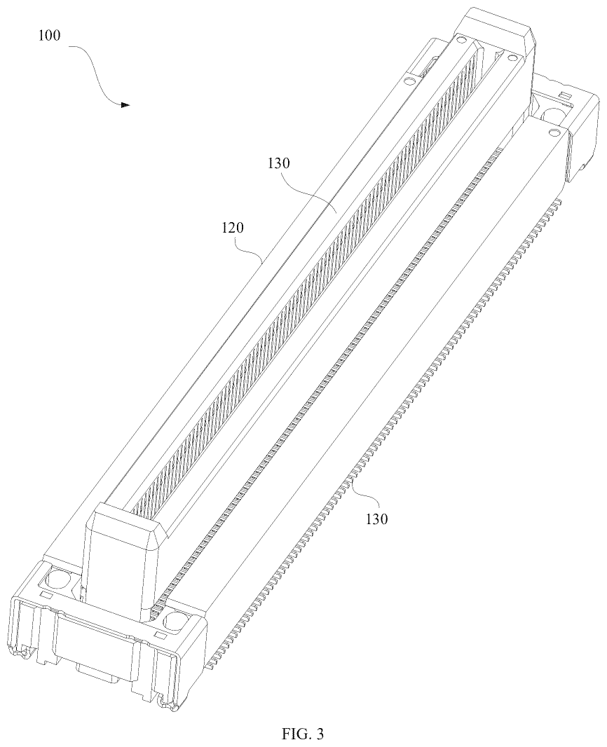

As shown in FIGS. 1 to 4, a floating connector assembly 10 according to an embodiment includes a first connector 100 and a second connector 200. The first connector 100 and the second connector 200 are in inserting connection with each other, so as to achieve a floating connection between the first connector 100 and the second connector 200. In this embodiment, the first connector 100 includes a stable-type electric-conducting terminal 110. Specifically, the first connector 100 further includes a first connecting base 120 and a floating socket 130. The first connecting base 120 defines a floating groove 122 and a first engaging slot 124 in communication with each other. The floating socket 130 is movably disposed in the floating groove 122, so that the floating socket 130 is movable relative to the first connecting base 120.

As shown in FIGS. 1 to 4, the floating socket 130 further defines a second engaging slot 132 and a first inserting slot 134 in communication with each other. One end of the stable-type electric-conducting terminal 110 is engaged in the first engaging slot 124, another end of the stable-type electric-conducting terminal 110 is engaged in the second engaging slot 132, and yet another end of the stable-type electrically conducting terminal 110 is positioned in the first inserting slot 134. The second connector 200 includes a second connecting base 210 and a male terminal 220. The second connecting base 210 defines a second inserting slot 212. The second inserting slot 212 is provided with an inserting tongue piece 2122 protruding therefrom. The male terminal 220 is provided in the second connecting base 210 and protrudes from the side wall of the inserting tongue piece 2122. The first connecting base 120 is inserted into the second inserting slot 212, the inserting tongue piece 2122 is inserted into the first inserting slot 134, and the male terminal 220 is elastically connected to the stable-type electric-conducting terminal 110, so that the first connector 100 is electrically connected to the second connector 200 when the first connector 100 and the second connector 200 are inserted with each other.

Furthermore, four male terminals 220 and four stable-type electric-conducting terminals 110 are provided. Four first engaging slot 124 and four second engaging slot 132 are provided. All of the four first engaging slots 124 are in communication with the floating groove 122. All of the four second engaging slots 132 are in communication with the first inserting slot 134. Two ends of each stable-type electric-conducting terminal 110 are engaged into the corresponding first engaging slot 124 and the corresponding second engaging slot 132, respectively, and each stable-type electric-conducting terminal 110 is elastically connected to the corresponding male terminal 220, so that each stable-type electric-conducting terminal 110 is electrically connected to the corresponding male terminal 220. Specifically, the four stable-type electric-conducting terminals include a first stable-type electric-conducting terminal, a second stable-type electric-conducting terminal, a third stable-type electric-conducting terminal, and a fourth stable-type electric-conducting terminal that are sequentially arranged side by side. The first and fourth stable-type electric-conducting terminals are both ground terminals, which jointly constitute a ground terminal group. The second and third stable-type electric-conducting terminals are both differential signal terminals, which jointly constitute a differential signal terminal group.

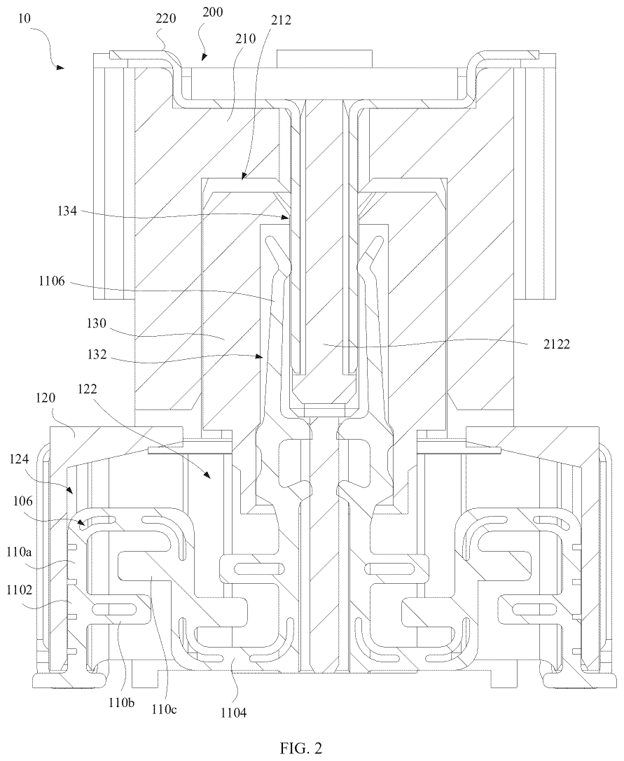

As shown in FIGS. 2, 4, 5, and 5a, in an embodiment, the stable-type electric-conducting terminal 110 includes an electric-conducting terminal body 110a, and a first interdigital piece 110b and a second interdigital piece 110c that are formed on the electric-conducting terminal body 110a, respectively. The electric-conducting terminal body 110a is formed with an interdigital forming region 102, and the first interdigital piece 110b and the second interdigital piece 110c both protrudes from an inner wall of the interdigital forming region 102. The first interdigital piece 110b and the second interdigital piece 110c are parallel to each other, and an interdigital gap 104 is formed therebetween, so as to form an inter-capacitance zone in the interdigital forming region 102. The electric-conducting terminal body 110a is formed with a plurality of floating deformation portions 1103 along an extending direction thereof. The electric-conducting terminal body 110a is sequentially provided with a plurality of first blanking holes 106 along the extending direction thereof. Each of the floating deformation portions 1103 is provided with at least one first blanking hole 106.

In the stable-type electric-conducting terminal 110, the electric-conducting terminal body 110a is formed with the interdigital forming region 102, and the first interdigital piece 110b and the second interdigital piece 110c both protrudes from the inner wall of the interdigital forming region 102. The first interdigital piece 110b and the second interdigital piece 110c are parallel to each other, and the interdigital gap 104 is formed therebetween, so that the stable-type electric-conducting terminal 110 form an inter-capacitance zone in the interdigital forming region 102, thereby improving the capacitance of the stable-type electric-conducting terminal 110 in the interdigital forming region 102, and thus enabling the stable-type electric-conducting terminal to have desirable inductive reactance. Moreover, the electric-conducting terminal body is formed with the plurality of floating deformation portions in the extending direction thereof. The electric-conducting terminal body is sequentially provided with the plurality of first blanking holes in the extending direction thereof. Each of the floating deformation portions is provided with at least one first blanking hole. As such, the electric-conducting terminal body has an improved floating performance and inductive reactance, and meanwhile the stable-type electric-conducting terminal have an improved band-pass filtering effect on high-frequency signal transmission, that is, have an obvious function of band-pass filtering on high-frequency signal transmission, thus avoiding a severe crosstalk problem existing between two adjacent electric-conducting terminals of the floating connector in the signal transmission process.

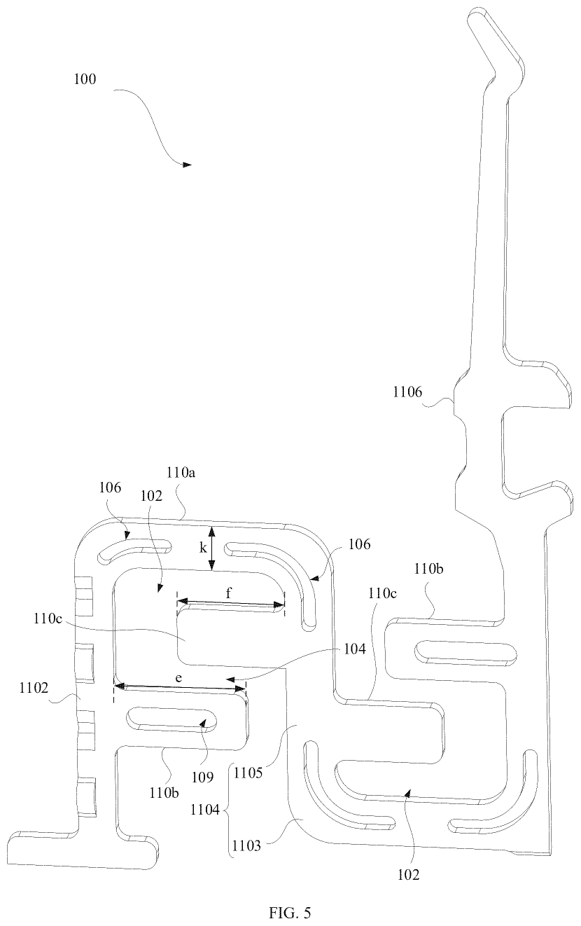

As shown in FIG. 5 or FIG. 5a, in the stable-type electric-conducting terminal 110 as described above, the first interdigital piece 110b and the second interdigital piece 110c are parallel to each other, and the interdigital gap 104 is formed therebetween, so that the stable-type electric-conducting terminal 110 form the inter-capacitance zone, i.e., a longitudinal interdigital structure, in the interdigital forming region 102, improving the capacitance of the stable-type electric-conducting terminal 110 in the interdigital forming region 102 and thus enabling the stable-type electric-conducting terminal to have an improved inductive reactance. Moreover, the electric-conducting terminal body 110a is provided with the first blanking holes 106, thus allowing the stable-type electric-conducting terminal 110 to have an improved band-pass filtering effect on high-frequency signal transmission, that is, have an obvious function of band-pass filtering on high-frequency signal transmission, thus avoiding a severe crosstalk problem existing between two adjacent electric-conducting terminals of the floating connector in the signal transmission process.

Further, referring to FIG. 5, the electric-conducting terminal body 110a includes a welding-fixed section 1102, a bending section 1104, and an engaging section 1106 that are sequentially connected. As shown in F IGs. 5 and 14, furthermore, the bending section 1104 has an N-shape or an S-shape. In an embodiment, the interdigital forming region 102 is formed between the bending section 1104 and the welding-fixed section 1102.

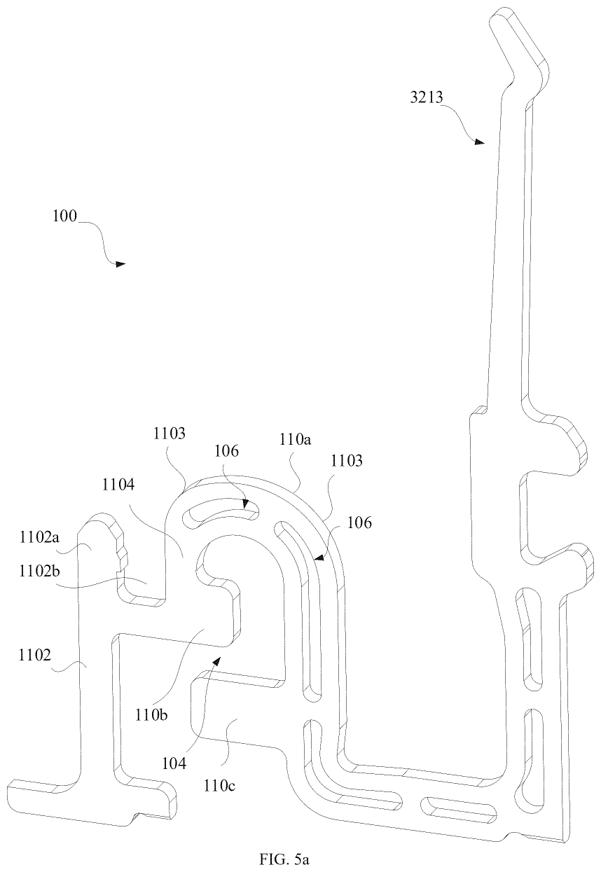

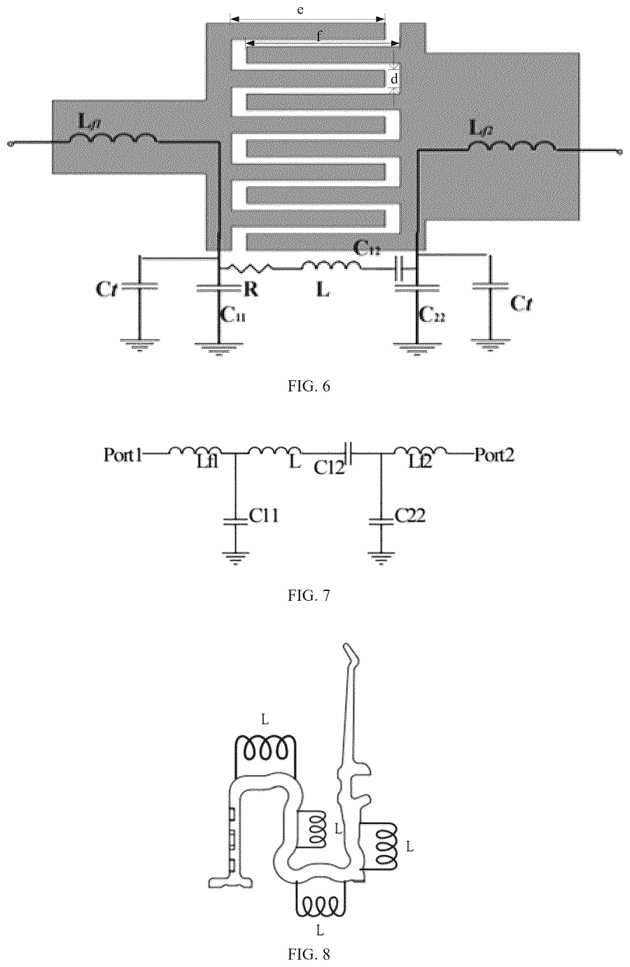

FIG. 6 shows an equivalent circuit diagram of a longitudinal interdigital structure. The welding-fixed section 1102 and the engaging section 1106 can be equivalent to the feeders on both sides of the longitudinal interdigital structure, respectively. L_{f1} and L_{f2} represent inductances of the two feeders, that is, the inductance corresponding to the welding-fixed section 1102 is represented as L_{f1}, and the inductance corresponding to the engaging section 1106 is represented as L_{f2}. Ct represents capacitance-to-ground of the terminal line. C₁₁ represents capacitance-to-ground of the first interdigital piece 110b, that is, the capacitance-to-ground of the left interdigital piece. C₂₂ represents capacitance-to-ground of the second interdigital piece 110c, that is, the capacitance-to-ground of the right interdigital piece. R represents resistance of the interdigital piece, L represents inductance of the interdigital piece, and C₁₂ represents the interdigital capacitance of the interdigital piece. Cₜ can be combined with C₁₁ and C₂₂, respectively. Suppose that the stable-type electric-conducting terminal 110 is made of a lossless material, R is negligible, and a simplified equivalent circuit diagram as shown in FIG. 7 can be obtained.

According to the simplified equivalent circuit, it can be known that the longitudinal interdigital structure is a band-pass model. C₁₂ in the equivalent circuit is equal to the value of the interdigital capacitance of the interdigital piece.

As shown in FIGS. 5 and 6, under the condition of a limited thickness dielectric plate, the thickness of the dielectric plate is much greater than an interdigital width as well as the interdigital gap 104. As shown in FIG. 6, in this embodiment, the interdigital width d refers to the width of the interdigital piece. In an embodiment, when the interdigital width is equal to the gap, the formula for calculating C₁₂ is as follows:

$$C ( pF ) = 3.937 \times {10}^{- 5} l ( {ε}_{r} + 1 ) [ 0.11 ( n - 3 ) + 0.252 ]$$

where n represents the number of the interdigital piece, l represents a length of the interdigital piece in unit of mm, and ε_{T} represents a dielectric constant of the dielectric plate.

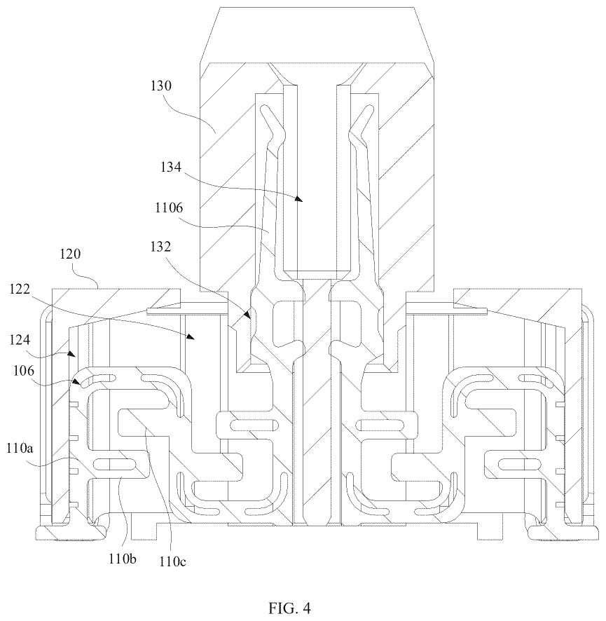

As shown in FIG. 4, in an embodiment, the dielectric plate is a plate base for mounting a floating terminal assembly. In this embodiment, the dielectric plate is a first connecting base 120 or a floating socket 130.

In an embodiment, when the interdigital width is not equal to the gap, the formula for calculating C₁₂ is as follows:

$$C ( pF ) = ( {ε}_{r} + 1 ) \{ 10.5 {( W / G )}^{0.3} + 0.3523 ( n - 3 ) [ 5.5452 - 8 ln ( tan \frac{π G}{4 ( G + W )} - tan {\frac{π G}{4 ( G + W )}}^{4} ) ] \} l$$

where G represents a constant coefficient, and W represents an interdigital width.

It can be seen from the above two formulas that, the interdigital capacitance C₁₂ has an increasing relationship with the interdigital length, and the interdigital capacitance Cu has a decreasing relationship with the interdigital gap 104. As shown in FIGS. 5 and 6, the interdigital length represents the length e of the first interdigital piece 101b or the length f of the second interdigital piece 110c. In this embodiment, the length e of the first interdigital piece 110b is equal to the length f of the second interdigital piece 110c, and both are equal to l.

For linear transmission of signals, the formulas for calculating the resulting linear inductance are as follows

$$L ( nH ) = 2 \times {10}^{- 4} [ ln ( \frac{l}{W + t} ) + 1.193 + 0.2 \; 235 \frac{W + t}{l} ] {K}_{g} ;$$

$${K}_{g} = 0.57 - 0.145 ln \frac{W}{h} ; \frac{W}{h} > 0.05 ;$$

where l represents a linear length in unit of nm, W represents a linear width: t represents a metal thickness, i.e., a terminal thickness, and h represents a thickness of the dielectric plate. It can be seen from the above formulas that the linear inductance L (nH) decreases with the increase of the line width w and increases with the increase of the line length l.

Similarly, the above-described formula for calculating the linear inductance is equally applicable to the inductance of the longitudinal interdigital structure. When applied to calculate the inductance of the longitudinal interdigital structure, l represents the interdigital length, and w represents the interdigital width. Similarly, it can be determined that the inductance of the longitudinal interdigital structure decreases with the increase of the interdigital width, and increases with the increase of the interdigital length. However, for a floating terminal assembly having the longitudinal interdigital structure, the value of the inductance of the longitudinal interdigital structure, i.e., the value of the interdigital inductance, is so small that it can be ignored.

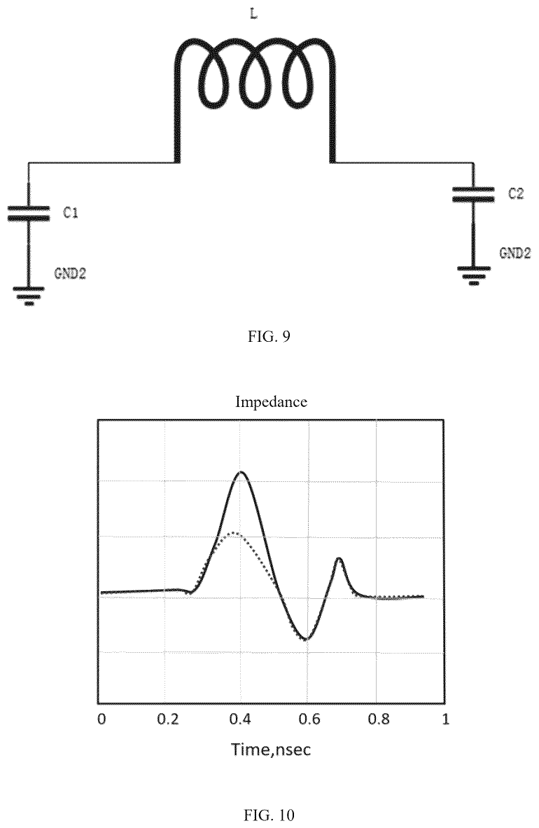

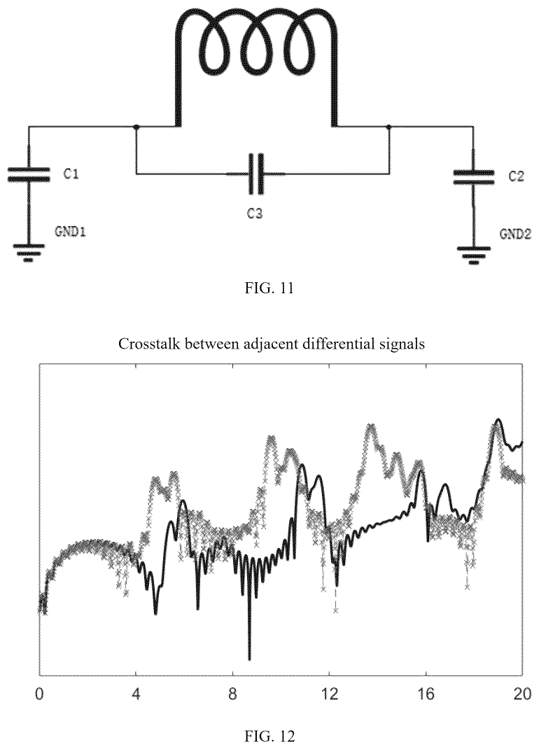

As shown in FIGS. 2 and 5, for the stable-ty pe electric-conducting terminal 110, the electric-conducting terminal body 110a has relatively high inductive reactance, and under a condition that the interdigital structure and the first blanking hole 106 are not provided, the equivalent circuit model of the electric-conducting terminal is shown in FIG. 8, the corresponding simplified equivalent circuit diagram is shown in FIG. 9, and the corresponding value of the resulting impedance peak is the peak value of the solid line in the impedance graph shown in FIG. 10. The simplified equivalent circuit diagram of the equivalent circuit model is shown in FIG. 11, and the corresponding value of the resulting impedance peak is the peak value of the dashed line in the impedance graph shown in FIG. 10, under a condition that the interdigital structure is provided, in other words, under a condition that the interdigital forming region 102 is formed between the bending section 1104 and the welding-fixed section 1102, the first interdigital piece 110b and the second interdigital piece 110c protrudes from the inner wall of the interdigital forming region 102, the first interdigital piece 110b and the second interdigital piece 110c are parallel to each other, and the interdigital gap 104 is formed between the first interdigital piece 110b and the second interdigital piece 110c, allowing the stable-type electric-conducting terminal 110 to form the inter-capacitance zone in the interdigital forming region 102. It can be seen that, the electric-conducting terminal body 110a is provided with interdigital pieces, i.e., provided with the first interdigital piece 110b and the second interdigital piece 110c, thereby improving the capacitance of the stable-type electric-conducting terminal 110 in the interdigital forming region 102, and thus enabling the stable-ty pe electric-conducting terminal to have desirable inductive reactance, i.e., enabling the inductive reactance of the stable-type electric-conducting terminal to be better adjusted to a preset value. The schematic diagram of signal crosstalk between the adjacent stable-type electric-conducting terminals 110 is shown as the star-dot curve in FIG. 12.

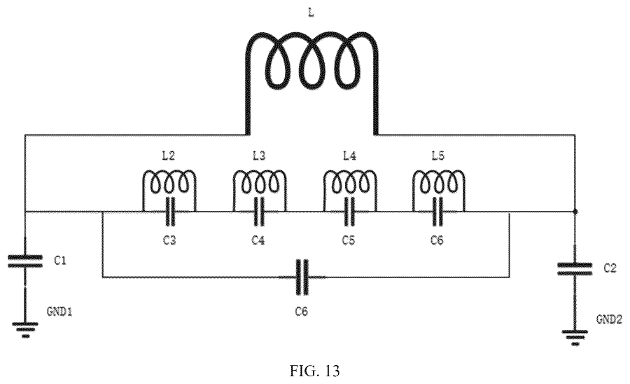

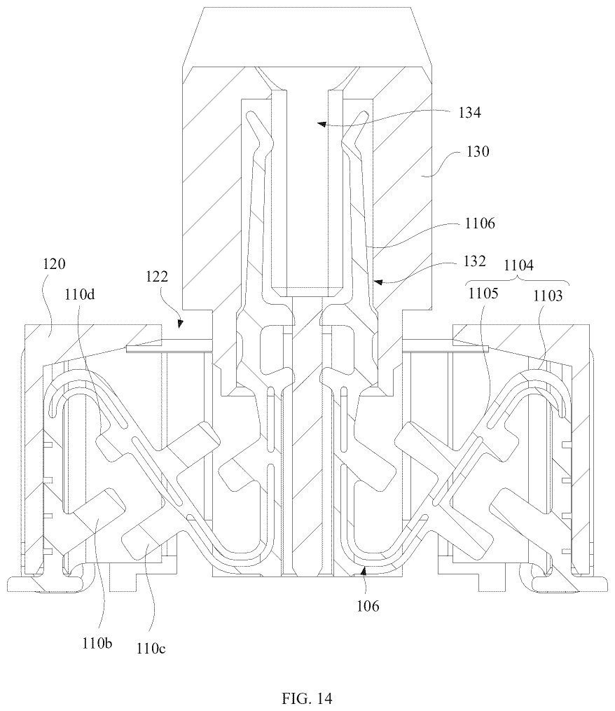

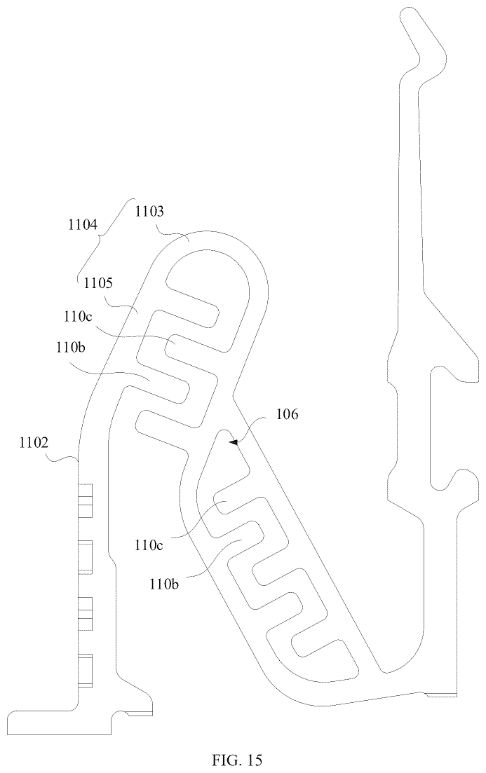

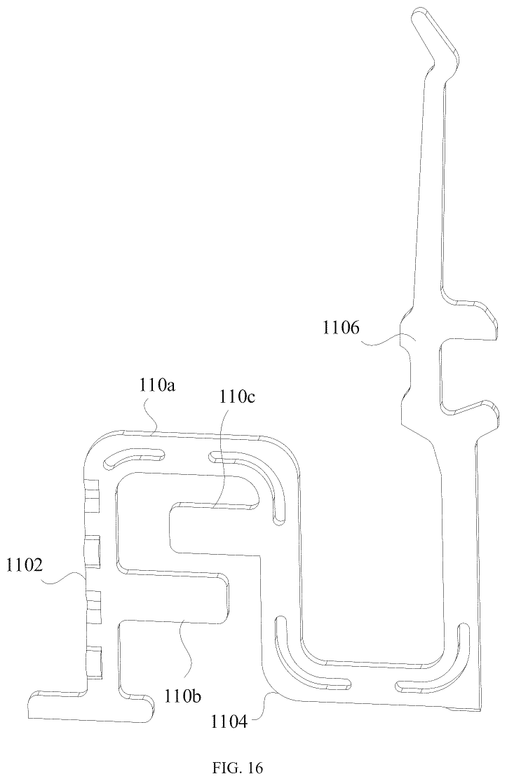

Further, the electric-conducting terminal body 110a is provided with a first blanking hole. In this embodiment, the electric-conducting terminal body 110a is provided with a plurality of first blanking holes 106, that is, the number of first blanking holes 106 is plural, the plurality refers to two or more, including two. The simplified equivalent circuit diagram of its equivalent circuit model is shown in FIG. 13. In this case, the schematic diagram of signal crosstalk between the adjacent stable-type electric-conducting terminals 110 is shown as the solid curve in FIG. 12. On the basis of loading the interdigital capacitance, according to the schematic diagram of signal crosstalk between the adjacent differential signals, it can be seen that the electric-conducting terminal body 110a provided with the plurality of first blanking holes 106, which enables the stable-type electric-conducting terminal 110 to have a desirable band-pass filtering effect on high-frequency signal transmission. In other words, the electric-conducting terminal body 110a is provided with the first blanking holes, which has an obvious function of band-pass filtering on high-frequency signal transmission, that is, the resonant frequency of the crosstalk is translated to a high frequency band, facilitating the bandwidth of signal transmission, and avoiding the severe crosstalk problem between two adjacent electric-conducting terminals of the floating connector assembly 10 during the signal transmission process. It should be understood that the number of first blanking holes 106 can be one, two, three, four, or more. As shown in FIG. 15, the number of first blanking holes 106 is one. As shown in FIG. 5 or FIG. 14, the number of first blanking holes 106 is four.

As shown in FIGS. 5 and 8, in an embodiment, the electric-conducting terminal body 110a is bent, and the bending section 1104 includes a plurality of floating deformation portions 1103 and a plurality of linear structures 1105. The plurality of floating deformation portions 1103 and the plurality of linear structures are spaced apart, and one linear structure is provided between two adjacent floating deformation portions 1103, so that the electric-conducting terminal body 110a not only has a desirable floating performance, but also can form more linear structures than that of the conventional electric-conducting terminal. As such, in the predetermined space between the welding-fixed section 1102 and the engaging section 1106, the electric-conducting terminal body 110a has a good linear inductance, allowing the electric-conducting terminal body 110a to have a good inductive reactance. In this embodiment, the interdigital forming region 102 is formed between the bending section 1104 and the welding-fixed section 1102 of the electric-conducting terminal body 110a. The bending section 1104 includes a plurality of floating deformation portions 1103 and a plurality of linear structures 1105. The plurality of floating deformation portions 1103 and the plurality of linear structures are spaced apart. One linear structure is provided between the two adjacent floating deformation portions 1103, and one floating deformation portion 1103 is provided between the two adjacent linear structures. The electric-conducting terminal body 110a can form more linear structures. As such, in the predetermined space between the welding-fixed section 1102 and the engaging section 1106, the electric-conducting terminal body 110a has a good linear inductance, allowing the electric-conducting terminal body 110a has a good inductive reactance. Further, bending directions of the plurality of floating deformation portions 1103 are different, so that the electric-conducting terminal body 110a has a relatively compact structure, and the bending section 1104 has more linear structures, and thus the bending section 1104 has a good inductive reactance. It can be understood that in other embodiments, as shown in FIG. 2a, the adjacent two floating deformation portions 1103 are not limited to be provided with one linear structure therebetween, that is, no linear structure is provided between the adjacent two floating deformation portions 1103.

As shown in FIG. 5, further, the length of the first interdigital piece 110b is equal to the length of the second interdigital piece 110c, so that a relatively long inter-capacitance zone is formed between the first interdigital piece 110b and the second interdigital piece 110c. Of course, in other embodiments, as shown in FIG. 5a, the length of the first interdigital piece 110b may not be equal to the length of the second interdigital piece 110c. For example, the length of the first interdigital piece 110b is less than the length of the second interdigital piece 110c.

As shown in FIG. 4, further, the welding-fixed section 1102 is engaged into the first engaging slot 124, so that the welding-fixed section 1102 is fixedly connected to the first connecting base 120. In other embodiments, the first connecting base 120 is further formed with a holding slot in communication with the first engaging slot 124. As shown in FIG. 5a, a fixed end 1102a is formed at a connecting position between the welding-fixed section 1102 and the bending section 1104, and the fixed end 1102a is engaged into the holding slot. As such, two ends of the welding-fixed section 1102 are engaged into the first engaging slot 124 and the holding slot, respectively, so that the welding-fixed section 1102 is more firmly fixed and connected to the first connecting base 120. Further, the bending section 1104 is formed with a holding avoidance slot 1102b on the other side of the portion where the first interdigital piece 110b is formed, so as to avoid interference when the fixed end 102a is engaged into the holding slot. Therefore, the fixed end 1102a can be reliably engaged into the holding slot, meanwhile reducing the space occupied by the bending section 110 in the floating direction, and thereby rendering the stable-type electric-conducting terminal 110 compact.

As shown in FIGS. 5 and 5a, in an embodiment, the plurality of first blanking holes 106 are spaced apart along a signal transmission direction of the electric-conducting terminal body 110a, that is, the electric-conducting terminal body 110a are provided with the plurality of first blanking holes 106 spaced apart from each other along the signal transmission direction of the electric-conducting terminal body 110a, which enables the electric-conducting terminal body 110a to have an improved band-pass filtering effect on high-frequency signal transmission, that is, have an obvious function of band-pass filtering on high-frequency signal transmission, and thus avoiding the severe crosstalk problem between two adjacent electric-conducting terminals of the floating connector assembly 10 during the signal transmission process. In other embodiments, the plurality of first blanking holes 106 are not limited to be spaced apart along the signal transmission direction of the electric-conducting terminal body 110a. For example, the distances between two adjacent first blanking holes 106 are not equal along the signal transmission direction of the electric-conducting terminal body 110a.

As shown in FIGS. 5, 14, 15, and 16, in an embodiment, the interdigital forming region 102 is formed on at least one side or at middle position of the electric-conducting terminal body 110a. As shown in FIG. 16. In this embodiment, the interdigital forming region 102 is formed on one side of the electric-conducting terminal body 110a. In other embodiments, the interdigital forming region 102 is not limited to be formed on one side of the electric-conducting terminal body 110a. For example, interdigital forming regions 102 are formed on two sides of the electric-conducting terminal body 110a, and the interdigital forming regions 102 on each side of the electric-conducting terminal body 110a are provided with first interdigital pieces 110b and second interdigital pieces 110c that are arranged alternately opposite to each other. Further, the number of the first interdigital piece 110b or the number of the second interdigital piece 110c is not limited to one. As shown in FIG. 5, for example, the number of first interdigital piece 110b and the number of second interdigital piece 110c are both two. As shown in FIG. 15, neither the number of first interdigital pieces 110b nor the number of second interdigital pieces 110c are limited to be the same. For example, the number of first interdigital piece 110b is more or less than the number of second interdigital piece 110c.

As shown in FIG. 14, in other embodiments, the interdigital forming region 102 is not limited to be formed on one or both sides of the electric-conducting terminal body 110a. As shown in FIG. 15, for example, the interdigital forming region 102 can also be formed at a middle position of the electric-conducting terminal body 110a. Specifically, the interdigital forming region 102 is provided on the inner peripheral wall of one of the first blanking holes 106, and the first interdigital piece 110b and the second interdigital piece 110c both protrude from the inner peripheral wall of the one of the first blanking holes 106.

As shown in FIG. 14, in one embodiment, each first blanking hole 106 is a curved strip-shaped slot, so that each first blanking hole 106 can be easily processed and formed and has a better capacitance. As shown in FIG. 15, in other embodiments, each first blanking hole 106 is not limited to a curved strip-shaped slot. For example, each first blanking hole 106 is a straight strip-shaped slot, a rectangular slot, a kidney-shaped slot, or other slots.

Further, each floating deformation portion 1103 is provided with at least one first blanking hole 106, so that each floating deformation portion 1103 has better elasticity, and thus the bending section 1104 has better elasticity, improving the floating performance of the conductive terminal body 110a, and meanwhile allowing the electric-conducting terminal body 110a to have better band-pass filtering effect on high-frequency signal transmission. In this embodiment, each floating deformation portion 1103 is provided with one first blanking hole 106, and the first blanking hole 106 extends along the extending direction of the center line of the floating deformation portion 1103.

As shown in FIGS. 5 and 14, furthermore, two ends of the bending section 1104 are both provided with at least one first blanking hole 106, that is, the positions of the bending section adjacent to the welding-fixed section 1102 and the engaging section 1106 are both provided with at least one first blanking hole 106, respectively, so that the electric-conducting terminal body 110a has a better band-pass filtering effect on high-frequency signal transmission.

As shown in FIGS. 5 and 14, in one embodiment, the center line of each first blanking hole 106 coincides with the center line of the electric-conducting terminal body 110a, which enables the stable-type electric-conducting terminal 110 to have better capacitance, thereby better improving crosstalk between adjacent signals during the transmission process, and enhancing the structural strength of the stable-type electric-conducting terminal 110.

As shown in FIGS. 5 and 14, in one embodiment, the transverse width of each first blanking hole 106 is constant everywhere along the direction perpendicular to the extending direction of the center line of the first blanking hole 106, so that the capacitance difference in the signal transmission direction at the first blanking hole 106 of the stable-type electric-conducting terminal 110 is relatively small. In this embodiment, the extending direction of the center line of the first blanking hole 106 coincides with the signal transmission direction of the stable-type electric-conducting terminal 110. The direction perpendicular to the extending direction of the center line of the first blanking hole 106 refers to the direction of the transverse width of the stable-type electric-conducting terminal 110, and also refers to the width direction of the stable-type electric-conducting terminal 110, as the k-direction shown in FIG. 5. The direction of the transverse width of each first blanking hole 106 is consistent with the direction of the transverse width of the stable-type electric-conducting terminal 110.

As shown in FIG. 5, in one embodiment, the width values of the transverse widths of any two first blanking holes 106 are equal, so that the capacitance difference at various positions of the stable-type electric-conducting terminal 110 is relatively small, and thus crosstalk between the adjacent signals of the stable-type electric-conducting terminal 110 is relatively small during the transmission process.

As shown in FIG. 14, in an embodiment, the stable-type electric-conducting terminal 110 further includes a third interdigital piece 110d protruding from the inner wall of the interdigital forming region 102. The third interdigital piece 110d and the second interdigital piece 110c are parallel to and staggered from each other. The second interdigital piece 110c and the first interdigital piece 110b are staggered from each other. Interdigital gaps 104 are formed between the third interdigital piece 110d and the second interdigital piece 110c, and between the second interdigital piece 110c and the first interdigital piece 110b. The interdigital gap 104 formed between the third interdigital piece 110d and the second interdigital piece 110c is a first interdigital gap. The interdigital gap 104 formed between the second interdigital piece 110c and the first interdigital piece 110b is a second interdigital gap. The first interdigital gap and the second interdigital gap are in communication with each other. In this embodiment, the interdigital structure includes the first interdigital piece 110b, the second interdigital piece 110c, and the third interdigital piece 110d. In other words, three interdigital pieces are provided. In other embodiments, the number of the interdigital sheets can also be four, five or other numbers. Further, the first interdigital gap is equal to the second interdigital gap, and neither the first interdigital gap nor the second interdigital gap is equal to the interdigital width. In other embodiments, the first interdigital gap and the second interdigital gap can also be equal to the interdigital width.

As shown in FIG. 5, in an embodiment, at least one of the first interdigital piece 110b and the second interdigital piece 110c is provided with a second blanking hole 109. In this embodiment, the first interdigital piece 110b is provided with the second blanking hole 109, so that the first interdigital piece 110b has a better capacitance. In other embodiments, the second blanking hole 109 is not limited to be provided on the first interdigital piece 110b. For example, the first interdigital piece 110b and the second interdigital piece 110c are each provided with the second blanking hole 109. Further, at least one of the first interdigital piece 110b, the second interdigital piece 110c, and the third interdigital piece 110d is provided with the second blanking hole 109, so that at least one of the first interdigital piece 110b, the second interdigital piece 110c, and the third interdigital piece 110d has a better capacitance. For example, all of the first interdigital piece 110b, the second interdigital piece 110c, and the third interdigital piece 110d are provided with the second blanking hole 109.

Compared to the prior art, the present disclosure has at least the following advantages:

In the stable-type electric-conducting terminal 110, the electric-conducting terminal body 110a is formed with the interdigital forming region 102, and the first interdigital piece 110b and the second interdigital piece 110c both protrudes from the inner wall of the interdigital forming region 102. The first interdigital piece 110b and the second interdigital piece 110c are parallel to each other, and the interdigital gap 104 is formed therebetween, so that the stable-type electric-conducting terminal 110 forms the inter-capacitance zone in the interdigital forming region 102, improving the capacitance of the stable-type electric-conducting terminal 110 in the interdigital forming region 102 and thus enabling the stable-type electric-conducting terminal to have desirable inductive reactance. Moreover, the electric-conducting terminal body is formed with the plurality of floating deformation portions in the extending direction thereof. The electric-conducting terminal body is sequentially formed with the plurality of first blanking holes in the extending direction thereof. Each of the floating deformation portions is provided with at least one first blanking hole. As such, the electric-conducting terminal body has an improved floating performances and inductive reactance, and meanwhile the stable-type electric-conducting terminal have an improved band-pass filtering effect on high-frequency signal transmission, that is, have an obvious function of band-pass filtering on high-frequency signal transmission, thus avoiding a severe crosstalk problem existing between two adjacent electric-conducting terminals of the floating connector in the signal transmission process.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

1. A stable-type electric-conducting terminal, comprising an electric-conducting terminal body, a first interdigital piece and a second interdigital piece that are formed on the electric-conducting terminal body, wherein the electric-conducting terminal body is formed with an interdigital forming region, the first interdigital piece and the second interdigital piece both protrude from an inner wall of the interdigital forming region, the first interdigital piece and the second interdigital piece are parallel to each other, and an interdigital gap is formed between the first interdigital piece and the second interdigital piece;
wherein the electric-conducting terminal body is formed with a plurality of floating deformation portions along an extending direction thereof, the electric-conducting terminal body is provided with a plurality of first blanking holes sequentially along the extending direction thereof, and each floating deformation portion is provided with at least one first blanking hole.

2. The stable-type electric-conducting terminal according to claim 1, wherein a plurality of the first blanking holes are provided, and the plurality of first blanking holes are spaced apart along a signal transmission direction of the electric-conducting terminal body.

3. The stable-type electric-conducting terminal according to claim 2, wherein each of the first blanking holes is a curved strip-shaped slot.

4. The stable-type electric-conducting terminal according to claim 3, wherein a center line of each first blanking hole coincides with a center line of the electric-conducting terminal body.

5. The stable-type electric-conducting terminal according to claim 3, wherein a transverse width of each first blanking hole is constant in a direction perpendicular to an extending direction of the center line of the first blanking hole.

6. The stable-type electric-conducting terminal according to claim 3, wherein width values of transverse widths of any two of the first blanking holes are equal.

7. The stable-type electric-conducting terminal according to claim 1, wherein at least one of the first interdigital piece and the second interdigital piece is provided with a second blanking hole.

8. The stable-type electric-conducting terminal according to claim 1, wherein the interdigital forming region satisfies one of the following conditions:
the interdigital forming region is formed on at least one side of the electric-conducting terminal body, and
the interdigital forming region is formed at a middle position of the electric-conducting terminal body.

9. A connector, comprising the stable-type electric-conducting terminal of claim 1.

10. A floating connector assembly, comprising the connector of claim 9.
